(19) United States
(12) Patent Application Publication
(10) Pub. No.: US 2026/0330777 A1
(43) Pub. Date: Oct. 22, 2026

(54) SYSTEMS AND METHODS FOR USE IN FACILITATING AUGMENTED REALITY SELECTION AND ADVANCEMENT

(71) Applicant: Monsanto Technology LLC, Saint Louis, MO (US)

(72) Inventors: Michael CALVILLO, Saint Charles, MO (US); Edward V. FISCHER, Jr., Cottleville, MO (US); Patrick PRIDGEN, Saint Louis, MO (US); Carrie ROY, Kirkwood, MO (US); Tania Nicole VAN ERT, Saint Louis, MO (US)

(21) Appl. No.: 19/121,417

(22) PCT Filed: Oct. 13, 2023
(86) PCT No.: PCT/US2023/035120

§ 371 Date: Apr. 15, 2025

Related U.S. Application Data
(60) Provisional application No. 63/417,538, filed on Oct. 19, 2022.

(51) Int. Cl. G06T 19/00; G02B 27/01; G06F 3/01

(52) U.S. Cl. CPC G06T 19/006; G02B 27/017; G06F 3/013

(57) ABSTRACT

An augmented reality selection and advancement system generally includes a head mounted display (HMD) with a viewing lens worn by a user. The system may also include a handheld selector device for interacting with the HMD when the user views a source tray and a destination tray as described. The HMD is configured to overlay, via the viewing lens, various graphic images when the user views an identified tray and/or takes one or more actions with regard to the tray and plants in the tray.

### CROSS-REFERENCE TO RELATED APPLICATION

This application claims the benefit of, and priority to, U.S. Provisional Patent Application No. 63/417,538, filed Oct. 19, 2022. The entire disclosure of the above application is incorporated herein by reference.

### FIELD

The present disclosure relates to selecting and advancing plants, for example, in a development process. More particularly, the present disclosure relates to systems and methods for use in advancing and discarding plants (or other objects such as, for example, bacterial or yeast colonies, insects or nematodes, etc.) from the development process, using augmented reality to overlay certain data specific to the plants (e.g., on source trays of the plants, etc.) and track and record which plants are advance and which are discarded.

### BACKGROUND

This section provides background information related to the present disclosure which is not necessarily prior art.

Currently, users select RO or first-generation germplasm plants for advancement using expensive custom-built, automated hardware systems, or poppers. The poppers are crop-type specific. Trays of plants are brought to the poppers, and the individual wells of the trays are sequenced through in order to advance or discard the plants in the wells. In particular, a user may place a source tray on a table and then evaluate each plant in the source tray for advancement, in order from one end of the source tray to the other. If the user chooses a source plant to be advanced, the user presses an advance button at the popper, causing a rod/piston to rise out of a corresponding hole of the table to pop the plant out of the source tray. The user then moves the plant to a destination tray, and inserts a stake with the plant having information corresponding to the plant. If the user rejects a source plant, the user presses a discard button and the popper prompts the user to insert a reason for discarding the plant. In doing so, the popper requires the user to step through each well of the source tray in a predetermined order.

### SUMMARY

This section provides a general summary of the disclosure, and is not a comprehensive disclosure of its full scope or all of its features.

An augmented reality selection and advancement system is described, for example, for use with a head mounted display (HMD). The HMD includes a processor operably coupled to a memory and the memory includes executable instructions that, when executed by the processor, cause the HMD to perform one or more of the operations described herein.

In some example embodiments, the executable instructions, when executed by the processor, cause the processor to activate a source tray and a destination tray identifier including accessing data related to an identified source tray and an identified destination tray stored in the memory. In doing so, the HMD overlays, via a viewing lens of the HMD, a source graphic image, when an HMD user views the identified source tray. The source graphic image corresponds to the stored source tray data. The source tray data includes data regarding a plurality of plants in a plurality of source tray plant wells and designates each plant in one of the plurality of source tray plant wells as one of an advance plant and a discard plant, and a well location for each well of the source tray. The HMD overlays, via the viewing lens, a destination graphic image, after the HMD user chooses one of the advance plants from the identified source tray and when the HMD user views the identified destination tray, the destination graphic image corresponding to the stored destination tray data. The HMD overlays, via the viewing lens, a discard graphic image, after the HMD user discards one of the other advance plants. The discard graphic image includes a plurality of discard reasons and prompts the HMD user to select at least one of the discard reasons and the selected reason(s) is(are) stored in the memory along with other information corresponding to the discarded plant. The HMD controls an advanced and discarded plant data tracker for storing and/or outputting data corresponding to the advance plants that were advanced or discarded.

Further areas of applicability will become apparent from the description provided. The description and specific examples in this summary are intended for illustration only and are not intended to limit the present disclosure.

### DRAWINGS

The drawings described are for illustrative purposes only of selected embodiments and not all possible implementations, and are not intended to limit the present disclosure.

FIG. 1 is a graphic illustration of an example system of the present disclosure;

FIG. 2 illustrates an example computing device, which may be included in the system of FIG. 1, or used to implement one or more of the methods herein.

FIG. 3 is a flow diagram of an example workflow of the present disclosure;

FIG. 4 is an illustration of an example input file of the present disclosure;

FIG. 5 is a flow diagram of an example workflow using a head mounted display (HMD) to provide an augmented reality (AR) of the present disclosure;

FIG. 6 is an illustration of an example source graphic image of the present disclosure;

FIG. 7 is an illustration of an example destination graphic image of the present disclosure;

FIG. 8 is an illustration of an example discard reason graphic image of the present disclosure;

FIG. 9 is an illustration of an example scan source graphic image of the present disclosure;

FIG. 10 is an illustration of an example scan destination graphic image of the present disclosure;

FIG. 11 is an illustration of an example review graphic image of the present disclosure;

FIG. 12 is an illustration of an example select workflow type graphic image of the present disclosure;

FIG. 13 is an illustration of an example select folder graphic image of the present disclosure; and

FIG. 14 is an illustration of an example enter quota graphic image of the present disclosure.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Typically, in plant selection, the user interacts with plant trays to move plants to advance or discard, by reference to a screen or monitor, whereby a disconnect may exist between the plants being selected and the actual plant in the tray. In this manner, incorrect plants may be advanced, and associated with traits that the plants do not actually possess. The improper advancement or retention of plants (or the improper discarding of plants), in this way, may disrupt the plant development process of which the plants are a part.

Uniquely, the systems and methods herein provide for a visual linkage between the plants in the tray and the trait data associated with the plant, through an augmented reality overlay of such data on the plant trays. In particular, plant data for the plants in the trays is overlayed on the plants in a user's field of view (e.g., superimpose a computer-generated image/graphic/icon on the user's view of the real world, to provide a composite view to the user; etc.), whereby the user is permitted to view various the plant data and interact with the plant associated with the data based on the overlay (as part of the augmented reality overlay). In this manner, the linkage between the data and the plant is apparent and clear to the user, in one place, whereby the advance or discarding of errant plants is reduced and/or eliminated. What's more, the plants may be tracked as advanced whereby data associated with the plants is linked to the new locations of the plants in destination trays. Overall, for example, an objective, efficient manner of providing data at the locations of the plants is provided, which improves efficiencies and accuracy of the associated plant development processes.

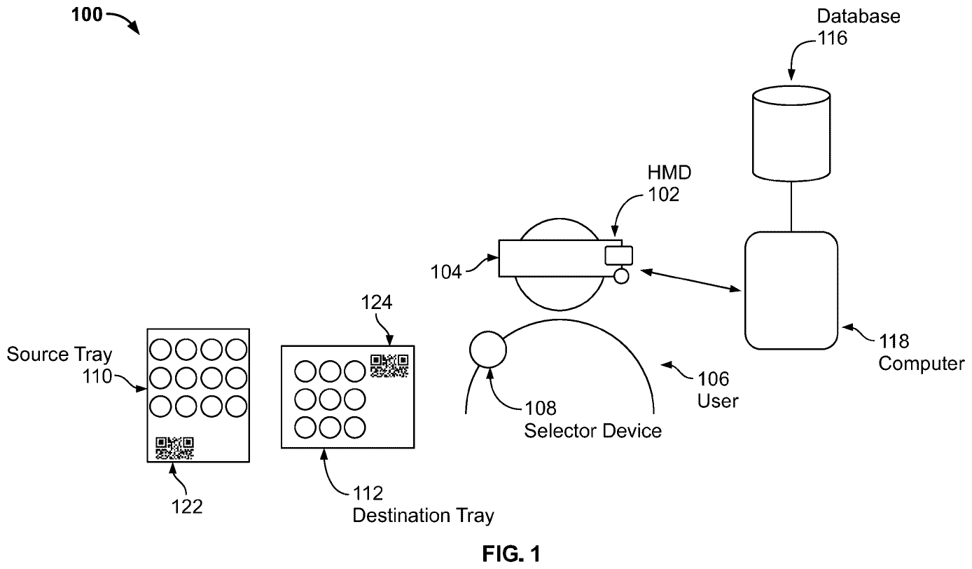

FIG. 1 illustrates an example augmented reality selection and advancement system 100 in which one or more aspects of the present disclosure may be implemented. Although the system 100 is presented in one arrangement, other embodiments may include the parts of the system 100 (or other parts) arranged otherwise depending on, for example, availability of trays, types of trays/plants being evaluated, and/or numbers of constructs, etc.

In this example embodiment, the augmented reality selection and advancement system 100 is shown in FIG. 1 and generally includes a head mounted display (HMD) 102, a source tray 110, which includes plants to be advanced (or not), and a destination tray 112 into which advance plants are to be deposited. The HMD 102 includes a viewing lens 104 and is shown being worn by a user 106. The system 100 may also include a handheld selector device 108 for interacting with the HMD 102 when the user 106 views the source tray 110 and the destination tray 112, as described below. The HMD 102 may be any commercially available head mounted display, such as, for example, the Hololens 2 AR headset sold by Microsoft® and the handheld selector device 112 may be any pointer or mouse compatible with the HMD 102, such as the Wireless Presenter, pointer finger ring, sold by Amerteer®.

The trays 110, 112 each include a plurality of wells, as represented by the circles. The trays 110, 112 may be any type of plant tray/flat suitable for the plants being evaluated, including commercially available flats used in the commercial nursery industry, or otherwise, etc. In this example, the trays 110, 112 are structured with various wells to include plants therein. In at least one example, the trays 110, 112 may be structured or otherwise configured to include various sizes of wells and/or well plates for wet lab work, etc. Given that, the trays 110, 112 herein should be understood to broadly cover any form or shape or size of plant receptable used in connection with plant development or otherwise, etc. In this example, the source tray includes twelve wells and the destination tray 112 includes nine wells. However, other numbers of wells may be included in the trays 110, 112 in other examples (e.g., 12, 16, 24, 30, 36, etc.). Each of the wells of the source tray 110 includes a plant, which has been grown, in this example, as a first-generation plant or RO plant developed in the associated plant development process. The plant may be corn, soybean, or other suitable plant for development. It should be appreciated that multiple source trays 110 and/or multiple destination trays 112 may be included in the system 100 in other embodiments.

The HMD 102 may be configured to communicate with one or more database 116 that contains certain data for the source tray 110, including, for example, assay data related to each plant included in the source tray 110, etc. The database 116 may be at a remote location and accessed by a computer 118 and/or the HMD 102 through one or more wired or wireless connections. Computer 118 may additionally or alternatively receive data regarding the source tray 110 that is shared by other involved parties via email or other communication methods.

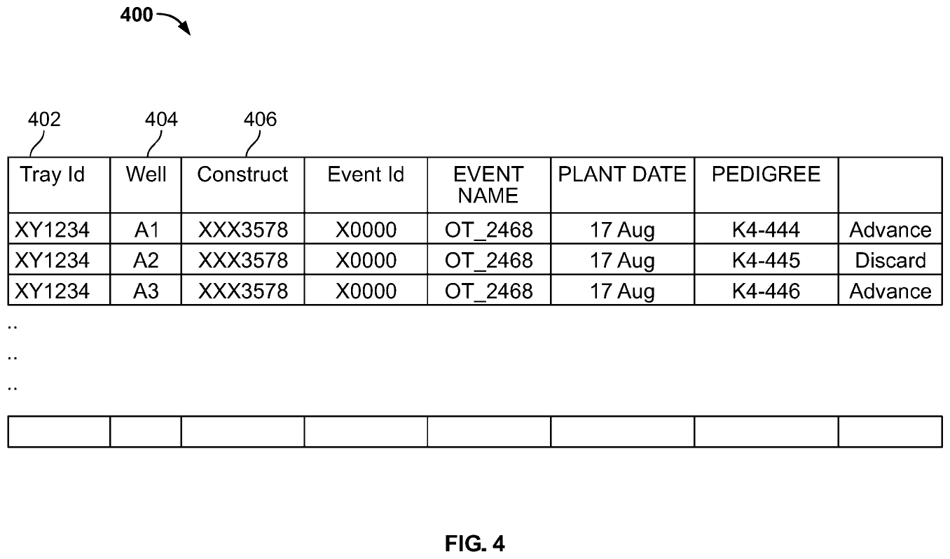

The computer 118 may be configured to combine data specific to the source tray 110 into an input file, such as a spreadsheet, . csv file, or other appropriate file format (e.g., as shown in FIG. 4 and described below, etc.). The input file may be transmitted to the HMD 102, via a wired or wireless connection, or physically, through a memory device, such as, for example, a USB thumb drive. The memory device containing the input file can then be inserted into a USB port (or other suitable port) of the HMD 102, where the HMD 102 loads the input file into a memory of the HMD 102.

It should be appreciated that the HMD 102 is configured to be loaded with multiple input files (e.g., individually, or in combination, etc.), whereby data related to multiple source trays 110 is included. Further, the data included in the input file(s) may include assay data, which is indicative of a certain trait or gene being present in the individual plants of the source tray 110. Additionally, or alternatively, in other embodiments, the certain data may include other genotypic or phenotypic information related to the plants. For example, the data may be indicative of color, type, variety, disease resistance, or any suitable data, by which a plant may be advanced or not in a plant development process. That said, the input file(s) also include data associated with location or grid coordinate data for the source tray 110, for example, to permit the data specific to the plant to be linked to the specific plant as located in the source tray 110 (e.g., to the specific well where the plant is located in the source tray, etc.).

As shown, in FIG. 1, the trays 110, 112 each includes labels. In particular, the source tray 110 includes a computer-readable indicia, or, in this example, a quick response or QR code 122, and the destination tray 112 includes a computer-readable indicia, or, in this example, a quick response or QR code 124. It should be understood that the computer readable indica on each tray is unique to the tray, whereby the tray may be distinguished from other trays. It should also be appreciated that other indicia may be used on the trays 110, 112 in other embodiments.

While the system 100 is described in the example embodiment above in connection with selecting and moving/advancing seeds/plants, it should be appreciated that in other example embodiments, the system may be used to select and advance other material/items, etc. For instance, the system ay be used to select and move/advance cells growing in a single well of a tissue culture plate, bacterial or yeast colonies, insects or nematodes, etc. In other words, the present disclosure should not be considered as limited to selecting and advancing plants.

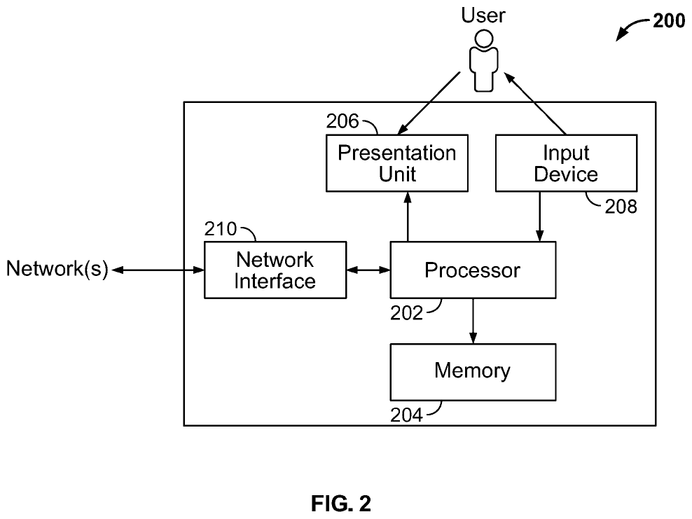

FIG. 2 illustrates an example computing device 200 that can be used in the system of FIG. 1 and/or with any of the workflows described herein. The computing device 200 may include, for example, one or more servers, workstations, personal computers, laptops, tablets, smartphones, virtual devices, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the HMD 102, the database 116, and the computer 118 may include or may be implemented in a computing device consistent with the computing device 200 (coupled to (and in communication with) the one or more networks). However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random-access memory (DRAM), static random-access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, profiles, rules, biometrics, entries, policies, formatting/encryption algorithms, biometric references, identifiers, and/or other types of data (and/or data structures) suitable for use as described herein. Furthermore, in various embodiments, computer-executable instructions may be stored in the memory 204 for execution by the processor 202 to cause the processor 202 to perform one or more of the functions described herein (e.g., one or more of the operations of the method flow diagrams herein, etc.), such that the memory 204 is a physical, tangible, and non-transitory computer readable storage media. Such instructions often improve the efficiencies and/or performance of the processor 202 and/or other computer system components configured to perform one or more of the various operations herein, whereby upon performance of the same the computing device 200 is transformed into a special purpose computer system. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, visually or audibly, for example, to a user of the computing device 200 (e.g., the user 106, etc.) (e.g., field of view overlays in the lens 104, etc.) whereby the information may be displayed at (or otherwise emitted from) computing device 200, and in particular at presentation unit 206.

The presentation unit 206 may include, without limitation, a transparent lens (e.g., the viewing lens 104, etc.), a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user of the computing device 200 (i.e., user inputs) such as, for example, user selections, etc., as further described herein. The input device 208 may include a single input device or multiple input devices. The input device 208 is coupled to (and is in communication with) the processor 202 and may include, for example, one or more of a keyboard, a pointing device, a handheld selection device, a camera, a touch sensitive panel (e.g., a touch pad or a touch screen, etc.), a scanner (e.g., a QR code scanner, etc.), another computing device, and/or an audio input device. In various example embodiments, a touch screen, such as that included in a tablet, a smartphone, or similar device, may behave as both the presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), or other device capable of communicating to one or more different networks herein and/or with other devices described herein. Further, in some example embodiments, the computing device 200 may include the processor 202 and one or more network interfaces incorporated into or with the processor 202.

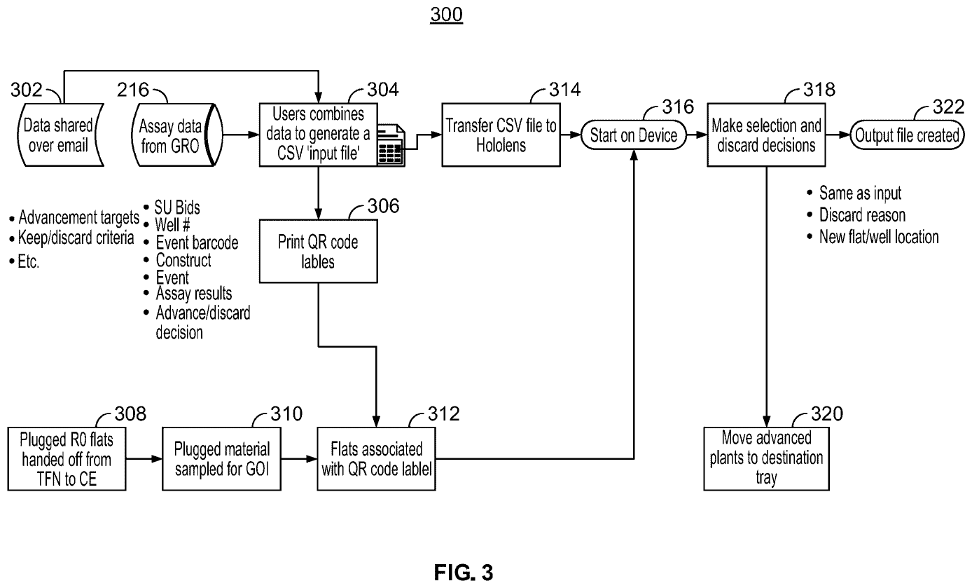

FIG. 3 shows an example of a selection and advancement workflow 300. The workflow 300 includes the database 116 mentioned above and data block 302 represents any data shared by others, such as via email, as mentioned above. The block 304 represents the user 106 creating the input file and block 306 represents printing the QR code labels 122, 124. Block 308 represents the origin of source tray 122 where the source tray 122 is plugged with germplasm/seeds containing a gene(s) of interest (GOI) whereby the plants are grown. Block 310 represents when the plants in the source tray 122 are assayed or otherwise tested/measured (e.g., depending on the data used for advancement, etc.) and based on the testing, each plant is designated as one of an advance plant (i.e., a candidate plant for advancement) or a discard plant and the results are part of the data stored in database 116 and the input file(s). Block 312 represents the QR code labels 122, 124 being attached to the source tray 110 and destination tray 112 as described above. Block 314 represents transferring the input file to the HMD 102 (e.g., via a network connection, via a storage media (e.g., a thumb drive, etc.), etc.).

FIG. 4 is a partial example of an input file, shown generally at 400. The input file 400 may include information fields including a source tray identifier 402, a source tray well location identifier 404 for each plant in the source tray 110 (which is a coordinate in this example), and a construct number 406 representing the specific change in the plant, such as, for example, a specific edit of the genome of the plant, or representing transgenic plants containing one or more GOI, etc. (e.g., include disease tolerance, stalk strength, treatment resistance, etc.). The input file 400 also includes an event identifier and event name, each indicative of the development event by which the plant was developed, a planting date for the plant (e.g., when germplasm/seed was deposited in soil, etc.), and a pedigree of the plant (e.g., an indication of its origin(s), or family line, etc.), along with an indication (as shown) of advance, discard, select, or other data to be displayed, via the HMD 102, to the HMD user 106, etc.

The HMD 102 is configured to be initiated at block 316. The user 106 wearing the HMD 102, i.e., the HMD user 106, views the plants in the source tray 110 (along with augmented reality data prompts) and makes plant selections from the assayed source tray 110, at block 318 (e.g., using the data in the input file (e.g., at least some of the data in the input file, all of the data in the input file, only the data in the input file, etc.), etc.). The details of the selection process are described below. The HMD user 106 moves the advance plants to the destination tray 112, at block 320. Once the HMD user 106 has made all the advance/discard selections for a particular gene of interest (there could be more than a single source tray 110) the advance plants, the discard decisions, and their associated information corresponding to the input file are used to create a similar output file to be transferred to the thumb drive, computer 118, and/or database 116 or other appropriate location, for later use.

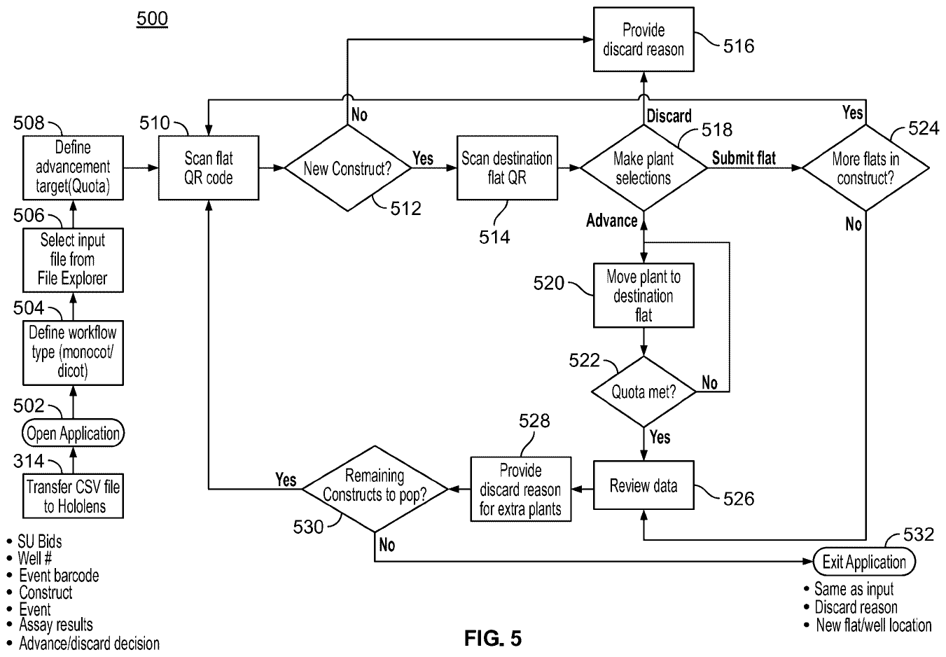

FIG. 5 shows an example workflow of using the HMD 102 generally at 500. The workflow 500 of FIG. 5 shows in detail the workflow blocks 318, 320, 322 of FIG. 3 (of workflow 300). The workflow 500 of FIG. 5 begins with the block 314 from FIG. 3 transferring the input file to the HMD 102 and then opening a plant advancement application stored in memory associated with the HMD 102, at block 502. At block 504, the type of plant is defined, e.g., monocot or dicot, etc. Next, block 506 represents the HMD user 106 selecting the input file from block 314, via a file explorer, for example, explained in more detail below. Next, block 508 represents the HMD user 106 defining/setting a target quota of a number of assayed plants to be advanced to the destination tray 112.

Before describing FIG. 5 further, it is noted that the HMD 102 includes a processor operably coupled to the memory therein. The memory includes executable instructions that, when executed by the processor, cause the processor to operate the plant advancement application stored in the memory (as opened at block 502), which causes the HMD 102 and the HMD user 106 to follow an augmented reality (AR) workflow to overlay data in the view of the HMD user 106, to select advance plants from the assayed storage tray 110 based on the data, and to place the advance plants in the destination tray 112, or alternatively to discard one or more of the advance plants and provide a reason for the discard decision.

In FIG. 5, block 510 represents where the HMD 102 is configured to identify the source tray 110, by scanning the QR code on each tray 110. The HMD 102, based on the QR code (and more specifically, the identifier represented thereby) is configured to access data related to an identified source tray 110 stored in the memory thereof, e.g., from the input file.

Block 512 then determines if the scanned QR code is a new construct. If not, block 514 represents presenting the HMD user 106 with a plurality of discard reasons for the construct.

Conversely, if, at 512, it is determined the scanned source tray 110 is a new construct, block 516 represents where the HMD 102 prompts the HMD user 106 to scan the QR code of the destination tray 112, whereby, again, the HMD 102 is configured to access data in memory related to the destination tray 112.

In connection with the above, the HMD 102 is configured to overlay icons on the trays 110, 112 indictive of the data associated with the plants, from the input file, whereby the HMD user 106 is guided or informed in connection with selection decisions.

Next, block 518 represents making plant selections from the source tray 110, e.g., by looking at the specific plant (via the HMD 102) and toggling the selector device 108, or by looking at the specific plant and moving the plant with the hand of the HMD user 106 (whereupon the HMD 102 detects the selection), etc. The decisions include, for example, to advance a plant from the source tray 110 to the destination tray 112 or to discard the plant. If the user 106 selects to discard a plant, block 514 prompts the HMD user 106 to provide a discard reason, which is presented to the HMD user 106 as an overlay graphic image. The user 106 selected discard reason is then stored in the memory of (or associated with) the HMD, for example, in an output file similar to the input file for the specific plant that was rejected. If a source tray plant is selected to be advanced (e.g., an advance plant, etc.) the HMD user 106 is prompted, at block 520, to move the advance plant to the destination tray 112. Following such movement, the block 522 represents the HMD 102 and the application determining if the plant quota set at block 508 has been met. If the quota have not been met, the HMD 102 and the application loops back to block 520, where the HMD user 106 continues selection of advance plants from the source tray 110.

The HMD user 106 may cause the HMD 102 and the application, at block 524, to prompt the user 106 to scan another source tray 110 of the same lot or construct of plants by returning to block 510.

If the quota is met at block 522 and/or there are no more source trays 510 to evaluate at block 524, the HMD 102 and the application prompt the HMD user 106, at block 526, to review the data for the advanced and the discarded plants. If there are source tray advance plants that were not advanced to the destination tray 112, the HMD 102 and the application, at block 528, redesignates these plants as extras or extra plants and prompts the HMD user 106 to provide a reason the extras were discarded.

After block 528, block 530 prompts the HMD user 106 to indicate if there are remaining source trays 110 to evaluate. If there are more source trays 110 to evaluate, the HMD 102 and the application loop back to block 510, and proceed as described above. If there are no more source trays 110 to evaluate, the HMD 102 exits the application at block 532. The output file may also be updated, as needed or desired. While only one source tray 110 is considered at a time in the above, it should be appreciated that multiple source trays 110 may be viewed at one time, or “active,” whereby the overlay in the HMD 102 is based on multiple input file(s) and/or data associated with the multiple source trays, for example, to view across the multiple trays and to make selections among multiple trays with the same construct, for example, more efficient, etc. Multiple destination trays may also be active at one time as well.

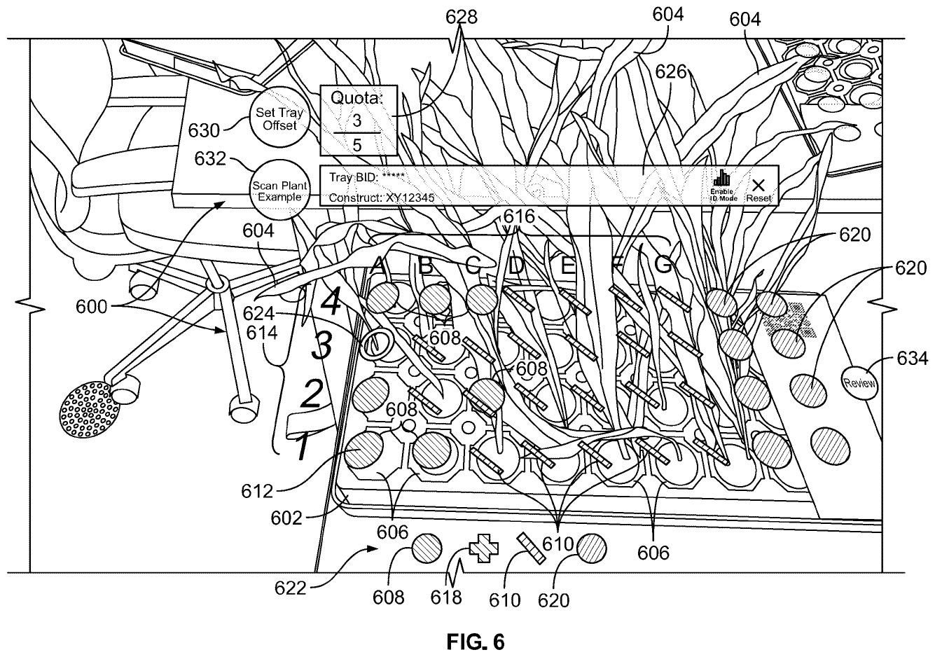

The workflow 500 of FIG. 5 will now be shown in a more detailed example with reference to FIGS. 6-14, including simulated graphic images presented to the HMD user 106 through the viewing lens 104.

As shown in FIG. 6, after the QR codes have been scanned, the HMD 102 overlays, via the viewing lens 104 of the HMD 102, a source graphic image 600, when the HMD user 106 views the identified source tray 602. The source graphic image 600 corresponds to the stored source tray data, in the input file. The stored source tray data includes data regarding a plurality of plants 604 in a plurality of source tray plant wells 606 including designating each plant 604 in one of the plurality of source tray plant wells 606 as one of an advance plant 608 and a discard plant 610 and a well location for each well of the source tray 602. The viewing lens 104 is a see-through lens and defines a user field of view (FOV) allowing the HMD user 106 to see the real-world environment the user 106 is in. The viewing lens 104 is also a holographic lens allowing graphic images to be presented to and overlayed on the real-world spots, places, things the HMD user 106 views or looks at.

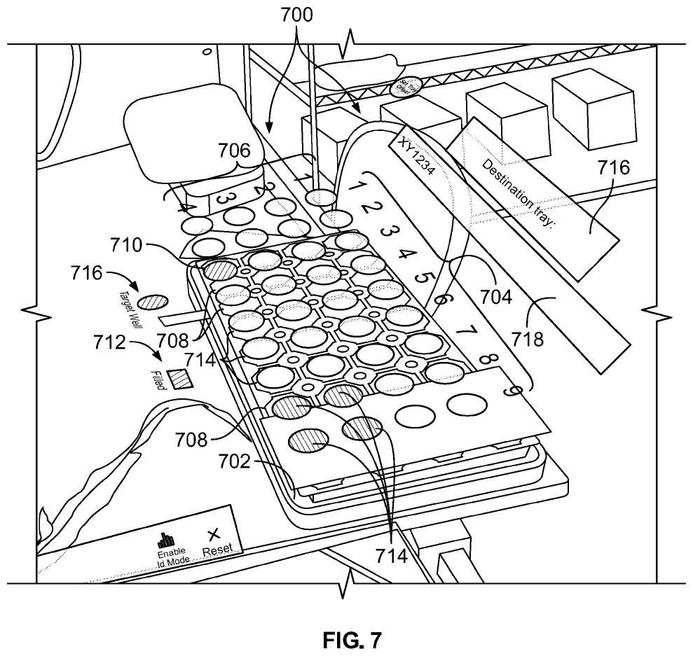

In addition, as shown in FIG. 7, the HMD 102 overlays, via the viewing lens 104, a destination graphic image 700, after the HMD user 106 chooses one of the advance plants 608 from the identified source tray 602 and as part of the user 106 viewing an identified destination try 702. When the HMD user 106 views the identified destination tray 702, the destination graphic image 700 corresponds to the stored destination tray data, in the input file.

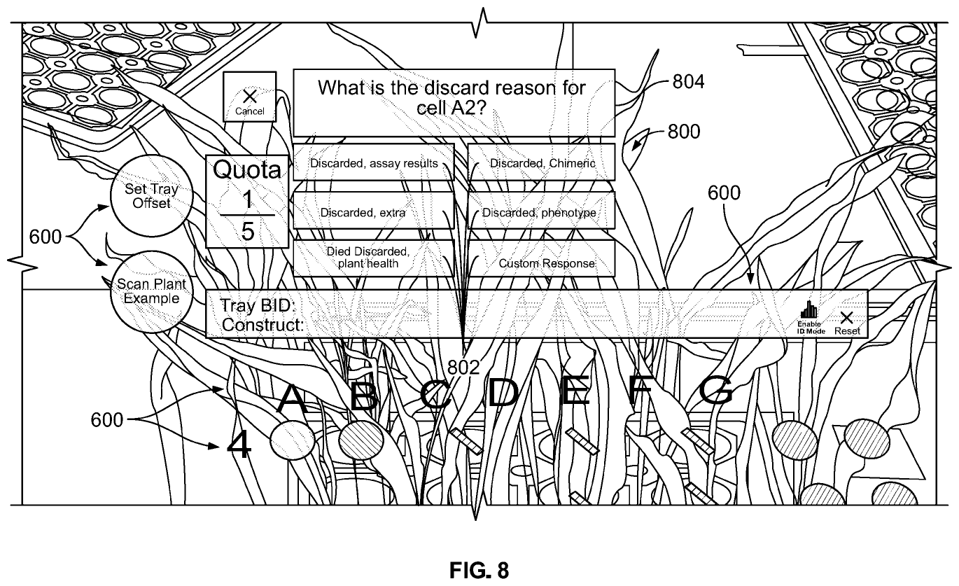

And, as shown in FIG. 8, the HMD 102 overlays, via the viewing lens 104, a discard graphic image 800, after the HMD user 106 discards another one of the advance plants 608. The discard graphic image 800 includes a plurality of discard reasons 802, and prompts, at 804, the HMD user 106 to select at least one of the discard reasons 802. The discard graphic image 800 is shown overlayed on the source graphic image 600. The chosen discard reason 802 is stored in of the HMD 102, for example, as part of an output file, similar to the input file. The plurality of discard reasons 802 includes various pre-populated options such as source health, extra, died, chimeric, phenotype, etc., as well as a custom option for the user 106 to provide a unique or custom reason/response (e.g., not included in the pre-populated options, etc.), in this example embodiment.

The HMD 102 and the plant advancement application control an advanced and discarded plant data tracker for storing and/or outputting data corresponding to the advance plants that were advanced or discarded, as discussed above.

In connection with the above, the handheld selector device 108 may be operably coupled to the HMD 102 for selecting or discarding one of the advance plants when the HMD user 106 views one of the advance plants (in the source tray 602) and activates one of an advance or discard button on the selector device 108. The advance or discard buttons may be reprogrammed left click and right click buttons of the device 108. It should be appreciated that the handheld device 108 may be omitted in one or more embodiments, where the hand, finger(s), etc., of the HMD user 106 may instead be tracked, detected and/or interpreted for inputs to the HMD 102 (e.g., to select, move, place, etc., the plants, buttons, inputs, etc., as described herein), whereby the HMD 102 interacts with the HMD user 106, etc. Further, in at least one embodiment, the handheld selector 108 is used in combination with the hand, finger(s), etc., of the HMD user 106 being tracked, detected and/or interpreted for inputs to the HMD 102, etc.

In the above images 600, 700, 800, the HMD 102, using an embedded eye tracker, may overlay a viewed location graphic image corresponding to where the HMD user 106 is looking or what the HMD user 106 is viewing. For instance, as shown in FIG. 6, the viewed location graphic image 612 is a spot in the example image 600, but may be other graphic images such as an X, a +, a ring, a sight scope with cross-hairs, or any other graphic image that is appropriate to the effective use of the application and HMD 102.

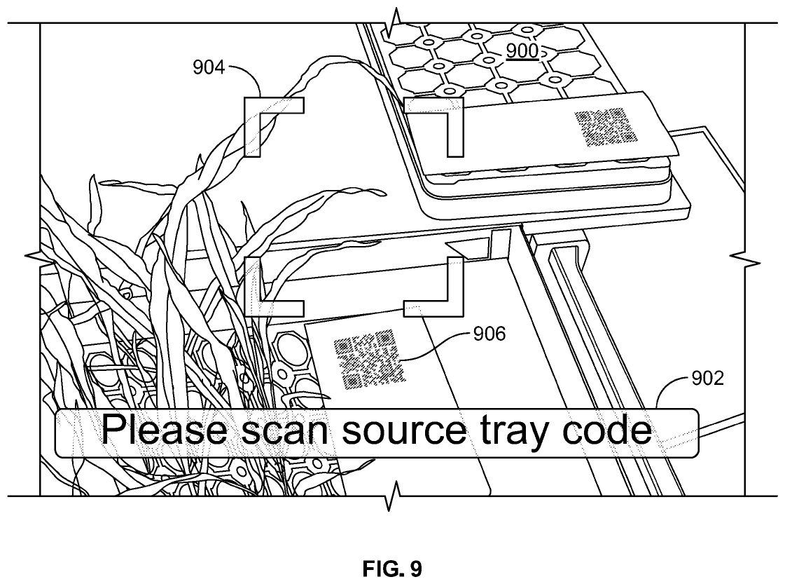

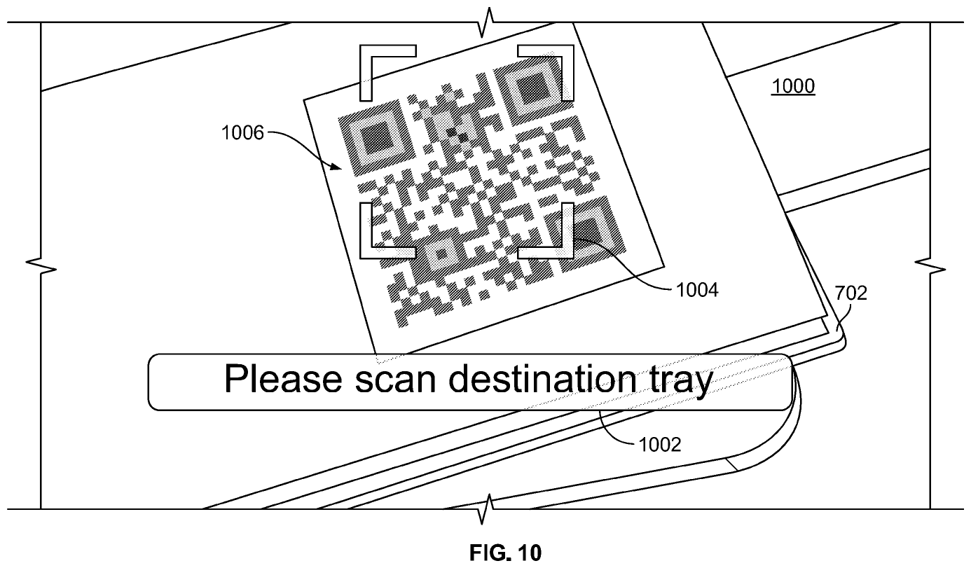

Operation of the source tray and destination tray identifier, of block 510, in this example, is a quick response (QR) reader embedded in the HMD 102, which prompts the user 106 to scan a corresponding QR code label attached to each of the source tray 110 and the destination tray 112, when the HMD user 106 views each of the QR code labels. In connection therewith, with reference to FIG. 9, the HMD 102 is configured to overlay, via the viewing lens 104, a scan source tray graphic image 900 that includes a scan source label 902 and a QR code target area 904 shown as a translucent segmented square. The HMD user 106 then changes the view, i.e., the user 106 moves his/her eyes and/or head until the source tray QR code 906 is generally within the target area image 904. The HMD's embedded eye tracker and head tracker allow the scan source tray graphic image 900 to properly align wit the user's view, at which time the QR code will be automatically scanned by the embedded QR code reader. Similarly, with reference to FIG. 10, the destination tray QR code may be scanned at block 516. The HMD 102 is configured to prompt the HMD user 106 to scan the destination tray 702 by overlaying, via the viewing lens 104, a scan destination tray graphic image 1000, and includes a scan destination tray label 1002 and a QR code target area 1004. The QR code label 1006, attached to the destination tray 702, is automatically scanned by the embedded QR code reader when the QR code target area 1004 is generally aligned with the QR code label 1006, as shown in FIG. 10.

As indicated above, the source tray and destination tray identifier of this example is a QR reader. However, it should be appreciated that the identifier may be any another device that identifies information regarding something attached to a product or thing, such as plant trays. For example, the source tray and destination tray may be identified based on a bar code, and/or a radio frequency identification (RFID) tag, etc. associated with the trays 602, 702

With reference again to FIG. 6, the source graphic image 600 includes an array (e.g., at the bottom of the image 600 in the illustrated example, etc.) with corresponding labels indicating a plurality of rows 614 and columns 616 of plant well locations in the source tray 602. The source graphic image 600 also includes a plurality of source graphic icons corresponding to each of the plant wells 616 including one of an advance icon 608, a discard icon 610, an extra icon 618, and an empty icon 620. A legend graphic image 622 is also part of source graphic image 600 and shows the source graphic icons by geometric shape and color. Using both shape and color allows the HMD user 106 to quickly identify wells and plants of interest and is especially helpful for people that have difficulty distinguishing certain colors. In the present example, the advance icon 610 is a circle (e.g., a green circle, etc. indicated by the slanted lines in the legend 622). The icons overlaying the tray 602 do not include any lines for clarity of presentation. In this example, the discard icon 610 is a slash (e.g., a red slash, etc. indicated by the vertical lines), the extra icon 618 is a plus sign (e.g., a blue or light blue plus sign, etc. indicated by the horizontal lines), and the empty icon 620 is a circle (e.g., a gray circle, etc. indicated by the horizontal dashed lines). The source graphic icons further include an advanced icon 624, which is a ring (e.g., a green ring, etc.), indicating the HMD user 106 selected the plant in the well corresponding to the location of the icon 624 overlaying the tray 602. The advance plant associated with the advanced icon 624 is moved by the HMD user 106 to the destination tray 702 as discussed below. The source graphic image 600 may further include a tray label icon 626 with a tray identifier number and a construct number, as shown. A quota label icon 628 indicating a target number of advance plants to be advanced to the destination tray 702 and a number of advance plants that have been advanced may also be part of source graphic image 600. If the source graphic image 600 is not well aligned with the source tray 602, the HMD user 106 may activate virtual button 630 to set the offset between the image 600 and the tray 602, to a more desirable position, as is known and is not described further in this example disclosure. If the HMD user 106 wants to stop evaluating tray 602 and begin evaluating another source tray, she may activate virtual button 632 to start the process. The image 600 may also include a virtual review button 634, the operation of which is discussed below.

It should be understood that in this embodiment, the above icons are located in the field of view, by reference to the QR code, but may be located with reference to another feature in the field of view including, for example, other indicia on the tray (e.g., corner markers, etc.), etc. It should also be appreciated that other icons or icons having different sizes, colors, shapes,, fill patterns, etc., may be used in other embodiments of the present disclosure.

With additional reference again to FIG. 7, the destination graphic image 700 includes an array with corresponding labels indicating a plurality of rows 704 and columns 706 of plant well locations in the destination tray 702, a plurality of destination graphic icons corresponding to each of the plant wells 708 including one of a target well icon 710, a filled icon 712, and an empty icon 714. In this example, the target well icon 710 is a circle (e.g., a green circle, etc. indicated by the slanted lines), the filled icon 712 is a square (e.g., a red square, etc. indicated by the vertical lines), and the empty icon 714 is a circle (e.g., a blue circle, etc. indicated by the horizontal lines in some of the icons 714). The destination graphic image 700 may also include graphic labels 716, 718 identifying the image 700 as including the destination tray 702 and displaying a destination tray identifier number.

It should be appreciated that when the HMD user 106 moves the plant to the well associated with the icon 710 of the destination tray 702, for example, the HMD 102 is configured to track the plant to the well associated with the icon 710. The tracking may include tracking related to the focus of the user 106 and a click to the handheld selector device 108, or tracking based on the content of the field of view (e.g., tracking the hand of the HMD user 106, etc.). The HMD 102 is also configured to associate the data specific to the plant to the well associated with the icon 710 (e.g., well 4-3), etc., whereby the data continues and/or flows with the movement of the plant to the destination tray 702. It should be appreciated that in one or more embodiments, the HMD 102 may be configured to indicate an error when the plant is placed in a well other than the well associated with the icon 710, via the viewing lens 104, thereby causing the HMD user 106 to reposition the plant in the correct well.

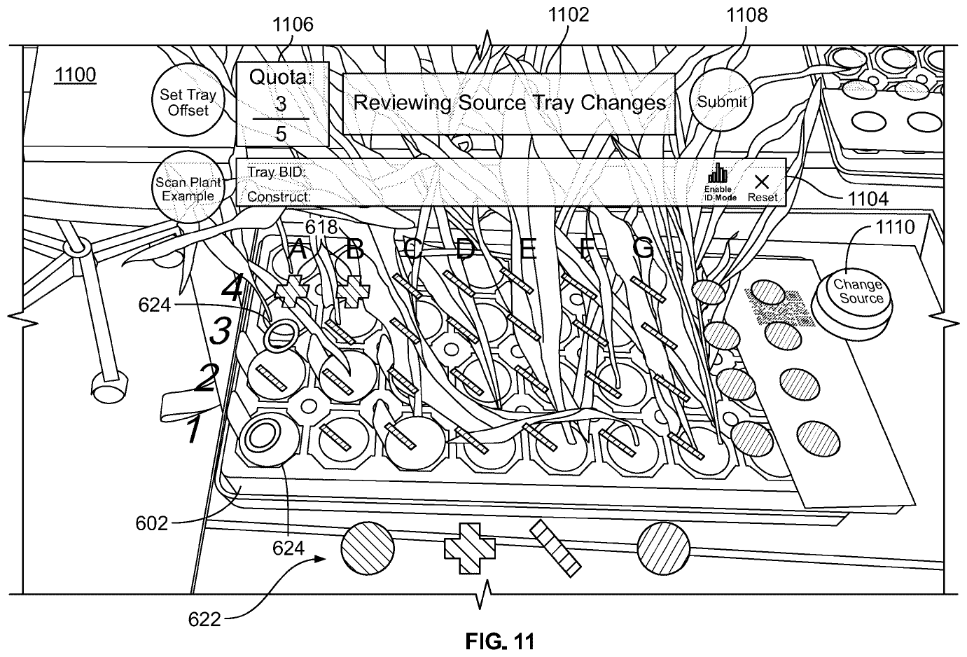

Referring now to FIG. 11, when the virtual review button 634 is selected by the HMD user 106 (e.g., by looking at the button and toggling the selector device 108, etc.), it causes the HMD 102 to overlay a review graphic image 1100, via the viewing lens 104. The review graphic image 1100 includes review labels 1102, 1104 that indicate the HMD user 106 is reviewing source tray 602 changes, a quota label 1106 indicating a target number (5 in this example) of advance plants to be advanced to the destination tray 702 and a number of advance plants that have been advanced (3 in this example), a submit virtual button icon 1108, and a change source virtual button icon 1110. A designation of any advance plants of source tray 602 that were not advanced to the destination tray 702 are automatically redesignated as extra plants in the output file created in the memory. The HMD 102 overlays, via the viewing lens 104, an extra graphic icon 618, as shown, corresponding to the redesignated advance plants and further may overlay, via the viewing lens 104, the discard graphic image 800 requiring the HMD user 106 to select a reason for discarding the now designated extra plants.

After the HMD user 106 provides a discard reason via the discard graphic image 800, while in the review mode, the HMD 102 and the application then cause an applies all graphic image (not shown) that includes an apply to all virtual button icon that, when selected, causes the selected discard reason to be applied to all advance plants that were not advanced to the destination tray 702 and stores such in the memory output file.

After the submit virtual button 1108 of the review graphic image 1100 is selected (e.g., by looking at the button and toggling the selector device 108, etc.), a final submit graphic image (not shown) is overlayed, via the viewing lens 104, including a yes virtual button and a no virtual button. When the yes virtual button is selected, the data for all the advance plants is saved in memory of (or associated with) the HMD 102, or the saved data is transferred to another device (e.g., a thumb drive, computer 118, or database 116, etc.), and an exit graphic image (not shown) is overlayed, via the viewing lens 106, including an exit virtual button and a start new quota virtual button.

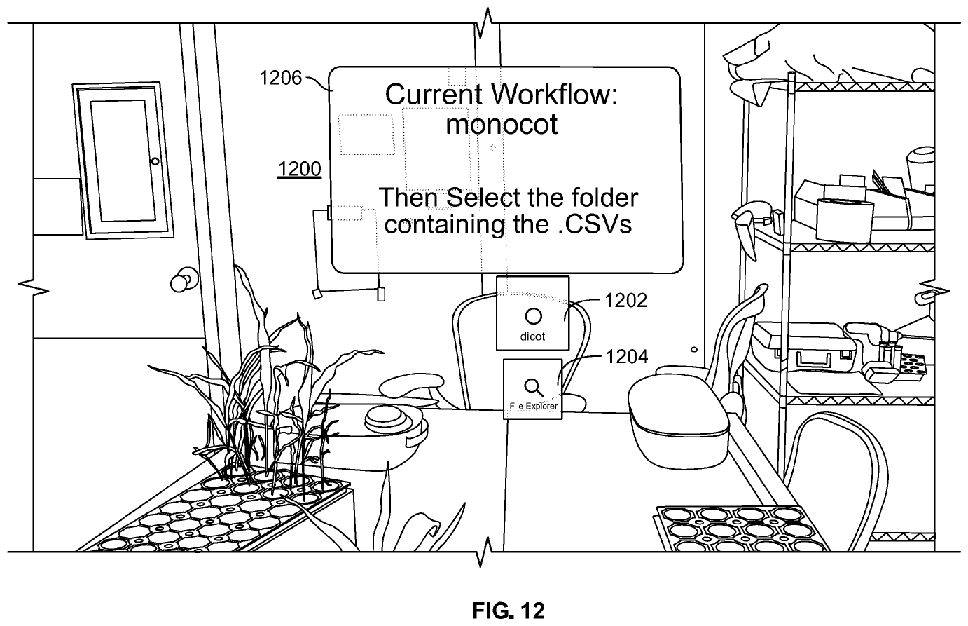

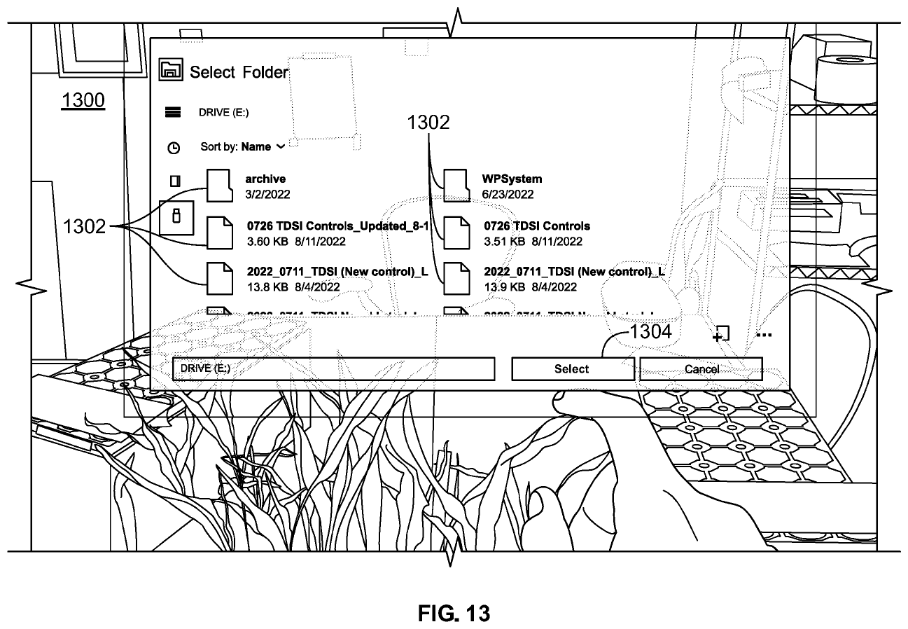

With reference to FIG. 12, the define workflow type, at block 504, where the HMD 102 and the application includes to overlay, via the viewing lens 104, provides a workflow graphic image 1100, including a monocot/dicot toggle virtual button 1102 and a file explorer virtual button 1104. The image 1100 may also include a label image 1106 with the current workflow type. When the monocot/dicot toggle virtual button 1102 is selected, the processor stores the chosen workflow type in the output file. When the file explorer virtual button 1104 is selected, the HMD 102 and the application further overlays, via the viewing lens, a select folder graphic image 1300, as shown in FIG. 13, including a plurality of folder icons 1302. When the HMD user 106 selects an appropriate one of the folder icons 1302, a data file (e.g., the input file of block 506, etc.) corresponding to the source tray 602 and the destination tray 702 is accessed by the application. The appropriate folder 1302 may be selected by highlighting the appropriate folder 1302 and selecting virtual select button icon 1304.

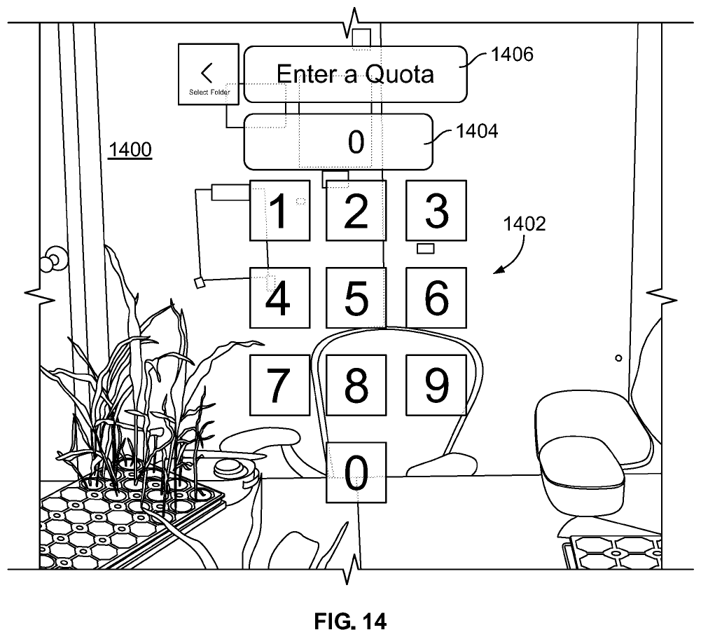

As shown in FIG. 14, the block 508 causes the HMD 102 and the application to further overlay, via the viewing lens 104, an enter quota graphic image 1400. The enter quota graphic image 1400 includes a virtual number pad 1402 for selecting a quota number of advance plants, shown at 1404 to be advanced to the destination tray 702. The image 1400 also includes an enter quota graphic label 1406 identifying the graphic image 1400 being viewed by the HMD user 106.

The HMD user 106 may select or discard each of the advance plants via the handheld selector device 108, via a HMD user 106 focusing on the button and selecting the selector device 108 or the HMD user 106 pushing a virtual button of the source graphic image corresponding to each of the advance plants, etc. For example, the HMD 102 may include an embedded hand position and motion tracker for detecting the finger pushing the virtual button. Or, the HMD 102 may include an embedded speech recognition engine. In connection therewith, the HMD 102 may be configured to recognize a voice of the HMD user 106 identifying a location of one of the advance plants, and saying “select,” “advance,” or “discard”, etc. (e.g., in lieu of pushing a button, or as instruction to push the appropriate button, etc.), or identifying/instructing one or more other operations as described herein.

A method of plant selection and advancement utilizing augmented reality was described above with respect to FIGS. 3 and 5 and the other figures as well.

The method of the present example disclosure may include one or more of the steps of: (a) loading a plant advancement application into a memory of a head mounted display (HMD), wherein the HMD includes a processor coupled to the memory; (b) overlaying, via a viewing lens of the HMD, a workflow graphic image, in a field of view (FOV) of an HMD user including the HMD user selecting a workflow type by toggling a monocot/dicot virtual button in the workflow graphic image; (c) selecting, a file explorer virtual button of the workflow graphic image; (d) overlaying, via the viewing lens, after the file explorer virtual button is selected, a select file graphic image including a plurality of file icons corresponding to files stored in the memory; I selecting one of the file icons corresponding to an input file stored in the memory, the input file having data defining a plurality of source tray data including defining a plurality of plants in a plurality of source tray plant wells including designating each plant in one of the plurality of source tray plant wells as one of an advance plant and a discard plant; (f) scanning a QR code attached to each of the source tray and a destination tray, using a QR code reader embedded in the HMD, including overlaying, via the viewing lens, a scan source tray graphic image including a scan source label and a QR code target area, by the HMD user viewing the source tray QR code and, after the source tray QR code is scanned, overlaying, via the viewing lens, a scan destination tray graphic image including a scan destination label and a QR code target area, by the HMD user viewing the destination tray QR code; (g) overlaying, via the viewing lens, a source graphic image, when the HMD user views the scanned source tray, the source graphic image corresponding to the stored source tray data; (h) overlaying, via the viewing lens, a destination graphic image, when the HMD user views the scanned destination tray, the destination graphic image corresponding to stored destination tray data in the input file; (i) selecting one of the advance plants from the source tray, when the HMD user views the source tray including changing a designation of a well of the selected advance plant to advanced; (j) overlaying, via the viewing lens, a target well graphic icon over one of a plurality of destination wells of the destination tray, when the HMD user views the destination tray, the target well graphic icon guiding the HMD user to place the advance plant in the destination well corresponding to the target well graphic icon; (k) overlaying, via the viewing lens, a discard graphic image, after the HMD user discards another advance plant, the discard graphic image, including a plurality of discard reasons prompting the HMD user to select at least one of the discard reasons; and (1) controlling an advanced and discarded plant data tracker for storing and/or outputting data corresponding to the advance plants that were advanced to the destination tray or discarded.

The method may further include tracking the plants to a specific location in the destination tray, or directing the advance plants to a specific location (e.g., well, etc.) in the destination tray. Further, the data associated with the plant to be advance may be further associated with and/or linked to the well of the destination tray to which the plant is advanced.

The foregoing description of the embodiments has been provided for illustration and description. It is not intended to be exhaustive or to limit the disclosure.

Individual elements or features of a particular embodiment are not limited to that embodiment, but, where applicable, are interchangeable and can be used in a selected embodiment, even if not specifically shown or described. The same may also be varied in many ways. Such variations are not to be deemed a departure from the disclosure, and all such modifications are included within the disclosure.

Example embodiments are provided so this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many forms and that neither should be construed to limit the disclosure. In some example embodiments, well-known processes, well-known device structures, and well-known technologies are not described in detail.

The terminology used is to describe particular example embodiments only and is not intended to be limiting. As used, the singular forms “a,” “an,” and “the” may be intended to include the plural forms, unless the context indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is described as being “on,” “engaged to,” “connected to,” or “coupled to” another element or layer, it may be directly on, engaged, connected or coupled to the other element or layer, or intervening elements or layers may be present. When an element is described as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used, the term “and/or” and the phrase “at least one of” includes all combinations of one or more of the associated listed items.

Although the terms first, second, third, etc. may describe various elements, components, regions, layers and/or sections, these elements, components, regions, layers and/or sections should not be limited by these terms. These terms may only distinguish one element, component, region, layer or section from another region, layer or section. Terms such as “first,” “second,” and other numerical terms when used imply no sequence or order unless clearly indicated by the context. A first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used for case of description to describe one element or feature's relationship to another element(s) or feature(s) as illustrated in the figures. Spatially relative terms may be intended to encompass different orientations of the device in use or operation besides the orientation depicted in the figures. If the device in the figures is turned over, elements described as “below” or “beneath” other elements or features would then be oriented “above” the other elements or features. The example term “below” can encompass both an orientation of above and below. The device may be otherwise oriented (rotated 90 degrees or at other orientations) and the spatially relative descriptors used, interpreted accordingly.

What is claimed is:

1. An augmented reality selection and advancement system, comprising:
a head mounted display (HMD);
wherein the HMD includes a processor operably coupled to a memory, and wherein the memory includes executable instructions that, when executed by the processor, cause the HMD to:
activate a tray identifier, including accessing data related to an identified source tray and an identified destination tray stored in the memory;
overlay, via a viewing lens of the HMD, a source graphic image, when an HMD user views the identified source tray, the source graphic image corresponding to the stored source tray data regarding a plurality of plants in a plurality of source tray plant wells, wherein the source graphic image includes a designation of each plant in one of the plurality of source tray plant wells as one of an advance plant and a discard plant and a well location for each well of the source tray;
overlay, via the viewing lens, a destination graphic image, after the HMD user selects one of the advance plants from the identified source tray and when the HMD user views the identified destination tray, the destination graphic image corresponding to the stored destination tray data;
overlay, via the viewing lens, a discard graphic image, after the HMD user discards a plant from the source tray, wherein the discard graphic image includes a plurality of discard reasons and a prompt for the HMD user to select at least one of the discard reasons; and
control an advanced and discarded plant data tracker for storing and/or outputting data corresponding to the advanced and/or discarded plants.

2. The system of claim 1, further comprising a handheld selector device operably coupled to the HMD for selecting one of the advance plants when the HMD user views one of the advance plants and activates one of an advance or discard button on the selector device.

3. The system of claim 1 wherein the executable instructions, when executed by the processor of the HMD, further cause the HMD to, using an embedded eye tracker of the HMD, overlay a viewed location graphic image corresponding to where the HMD user is looking.

4. (canceled)

5. The system of claim 1 wherein the tray identifier is one of a quick response (QR) reader, a bar code reader, and a radio frequency identification (RFID) tag reader.

6. (canceled)

7. The system of claim 1, wherein the source graphic image includes an array with corresponding labels indicating a plurality of rows and columns of plant well locations in the source tray, a plurality of source graphic icons corresponding to each of the plant wells including one of an advance icon, a discard icon, an extra icon, and an empty icon.

8. The system of claim 7, wherein the advance icon is a circle, the discard icon is a slash, the extra icon is a plus sign, and the empty icon is a circle; or wherein the source graphic icons further include an advanced icon, and wherein the advanced icon is a ring.

9.-10. (canceled)

11. The system of claim 1, wherein the HMD includes an embedded eye tracker, and wherein the embedded eye tracker is operable to determine where the HMD user is looking and what the HMD user is viewing in an HMD field of view.

12. The system of claim 1, wherein the stored source tray data includes a configuration of rows and columns of a plurality of wells of the source tray, a source tray identifier, a well location for each source, and a construct identifier for each source; and/or
wherein the destination graphic image includes an array with corresponding labels indicating a plurality of rows and columns of plant well locations in the destination tray, a plurality of destination graphic icons corresponding to each of the plant wells including one of a target well icon, a filled icon, and an empty icon.

13. (canceled)

14. The system of claim 12, wherein the target well icon is a circle, the filled icon is a square, and the empty icon is a circle.

15. The system of claim 1, wherein the discard graphic image includes a plurality of discard reasons and a message prompt configured to receive an input from the HMD user of at least one discard reason for the advance plant; and
wherein the executable instructions, when executed by the processor, further cause the HMD to store the received at least one discard reason in the memory.

16. The system of claim 15, wherein in the plurality of discard reasons includes one or more pre-populated options and/or an option for a custom reason.

17. The system of claim 1, wherein the source graphic image includes a review virtual button icon;
wherein the executable instructions, when executed by the processor, further cause the HMD, when the review virtual button icon is selected by the HMD user, to overlay a review graphic image, via the viewing lens;
wherein the review graphic image includes a review label indicating the HMD user is reviewing source tray changes, a quota label indicating a target number of advance plants to be advanced to a destination tray and a number of advance plants that have been advanced, a submit virtual button icon, and a change source virtual button icon;
wherein, the executable instructions, when executed by the processor, cause the HMD, after the submit virtual button of the review graphic image is selected, to overlay a final submit graphic image, via the viewing lens, including a yes virtual button and a no virtual button; and
wherein the executable instructions, when executed by the processor, cause the HMD, when the yes virtual button is selected, to:
save the data for all the advance plants;
transfer the saved data to another device; and
overlay an exit graphic image, via the viewing lens, including an exit virtual button and a start new quota virtual button.

18.-19. (canceled)

20. The system of claim 1, wherein a designation of any advance plants that were not advanced to the destination tray are automatically redesignated as extra plants, and wherein the executable instructions, when executed by the processor, further cause the HMD to:
overlay, via the viewing lens, an extra graphic icon corresponding to the redesignated advance plants; and then
overlay, via the viewing lens, the discard graphic image including a prompt requiring the HMD user to select a reason for discarding the extra plants; and
wherein the discard graphic image includes an apply to all virtual button icon, and wherein the executable instructions, when executed by the processor, further cause the HMD, when the discard graphic image is selected, to apply the selected reason to all advance plants that were not advanced to the destination tray.

21.-23. (canceled)

24. The system of claim 1, wherein the executable instructions, when executed by the processor, further cause the HMD to overlay, via the viewing lens, a workflow graphic image including a monocot/dicot toggle virtual button and a file explorer virtual button.

25. The system of claim 24, wherein the executable instructions, when executed by the processor, cause the HMD, when the monocot/dicot toggle virtual button is selected, to store a chosen workflow type;
wherein the executable instructions, when executed by the processor, cause the HMD, when the file explorer virtual button is selected, to overlay, via the viewing lens, a select folder graphic image including a plurality of folder icons;
wherein the executable instructions, when executed by the processor, cause the HMD, when the HMD user selects an appropriate one of the folder icons, to access a data file corresponding to the source tray and the destination tray;
wherein the executable instructions, when executed by the processor, further cause the HMD to overlay, via the viewing lens, an enter quota graphic image; and
wherein the enter quota graphic image further includes a virtual number pad for selecting a quota number of advance plants to be advanced to the destination tray.

26.-29. (canceled)

30. The system of claim 5, wherein the executable instructions, when executed by the processor, further cause the HMD to overlay, via the viewing lens, a scan source tray graphic image including a scan source label and a QR code target area.

31. The system of claim 30, wherein the executable instructions, when executed by the processor, further cause the HMD to overlay, via the viewing lens, a scan destination tray graphic image including a scan destination tray label and a QR code target area.

32. The system of claim 1 wherein the HMD includes an embedded hand position and motion tracker for detecting a finger of the HMD user pushing a virtual button of the source graphic image to select or discard an advance plant;
and/or wherein the HMD includes an embedded speech recognition engine for detecting a voice command of the HMD user identifying a location of one of the advance plants to select or discard and/or instructing advance or discard of one of the advance plants; and/or wherein the HMD includes a handheld selector device operable to select or discard an advance plant.

33. -34. (Cancelled).

35. A method of selection and advancement utilizing augmented reality, the method comprising:
overlaying, via a viewing lens of a head mounted display (HMD), a workflow graphic image, in a field of view (FOV) of an HMD user;
receiving a selection of a workflow type by toggling a monocot/dicot virtual button in the workflow graphic image;
receiving a selection of a file explorer virtual button in the workflow graphic image;
overlaying, via the viewing lens, after the file explorer virtual button is selected, a select file graphic image including a plurality of file icons corresponding to files stored in a memory;
receiving a selection of one of the file icons in the file graphic image corresponding to an input file stored in the memory, the input file having data defining a plurality of source tray data regarding a plurality of plants in a plurality of source tray plant wells, including a designation of each plant in one of the plurality of source tray plant wells as one of an advance plant and a discard plant;
scanning a QR code attached to each of the source tray and a destination tray, using a QR code reader embedded in the HMD, including overlaying, via the viewing lens, a scan source tray graphic image including a scan source label and a QR code target area, based on the HMD user viewing the source tray QR code and, after the source tray QR code is scanned, overlaying, via the viewing lens, a scan destination tray graphic image including a scan destination label and a QR code target area, based on the HMD user viewing the destination tray QR code;
overlaying, via the viewing lens, a source graphic image, when the HMD user views the scanned source tray, the source graphic image corresponding to the stored source tray data;
overlaying, via the viewing lens, a destination graphic image, when the HMD user views the scanned destination tray, the destination graphic image corresponding to stored destination tray data in the input file;
selecting one of the advance plants from the source tray, when the HMD user views the source tray, including changing a designation of a well of the selected advance plant to advanced;
overlaying, via the viewing lens, a target well graphic icon over one of a plurality of destination wells of the destination tray, when the HMD user views the destination tray, the target well graphic icon guiding the HMD user to place the advance plant in the destination well corresponding to the target well graphic icon;
overlaying, via the viewing lens, a discard graphic image, after the HMD user discards another advance plant, the discard graphic image, including a plurality of discard reasons prompting the HMD user to select at least one of the discard reasons; and
controlling an advanced and discarded plant data tracker for storing and/or outputting data corresponding to the advance plants that were advanced to the destination tray or discarded.

36. An augmented reality selection and advancement system, comprising:
at least one source tray and at least one destination tray;
a head mounted display (HMD) having a see-through viewing lens, an eye tracker subsystem, an identification code reader, and a graphic overlay subsystem;
a handheld selection device operatively coupled to the HMD having at least an advance button and a discard button;
a processor and an associated memory each connected to and mounted in the HMD;
wherein the identification code reader identifies a source tray code attached to the source tray and identifies a destination tray code attached to the destination tray;
wherein, after the source tray and the destination tray have been identified, the memory comprises executable instructions that, when executed by the processor, cause the processor to:
overlay a source graphic image via the viewing lens corresponding to a viewed position of the source tray, including graphical icons identifying each of a plurality of plants in the source tray as one of advance or discard, wherein the overlay graphic image is generated from source tray data stored in the memory associated with the identified source tray code;
detect a user viewing an advance plant and further detect the user choosing the viewed plant by sensing the user activating the advance button;
direct the user to move the chosen plant to the destination tray by overlaying a destination graphic icon corresponding to a predetermined well of the destination tray and store the predetermined well and the chosen plant data in the memory;
detect the user viewing another advance plant and further detect the user rejecting the viewed another advance plant by sensing the user activating the discard button;
display a discard graphic overlay, via the viewing lens, including a list of discard reasons and require the user to choose one of the discard reasons as the reason the another advance plant was discarded, by detecting the user activating a select button of the handheld selection device and store the chosen discard reason in the memory;
determine if there are additional source trays to view based on the source tray data stored in the memory associated with the identified source tray code; and
display a quota met graphic overlay when a preset quota of a number of advance plants have been chosen and moved to the destination tray.
